(19) United States
(12) Patent Application Publication
(10) Pub. No.: US 2024/0215548 A1
(43) Pub. Date: Jul. 4, 2024

(54) Bird Feeding Device

(71) Applicant: Tom BUTLER, Wisconsin Dells, WI (US)

(72) Inventor: Tom BUTLER, Wisconsin Dells, WI (US)

(21) Appl. No.: 18/090,863

(22) Filed: Dec. 29, 2022

(51) Int. Cl. A01K 39/012

(52) U.S. Cl. CPC A01K 39/0125

(57) ABSTRACT

A bird feeding device for automated addition of bird feed to a tray includes a dispensing apparatus and a tray, which are mountable to a support element, such as a post. The dispensing apparatus comprises a hopper, which has a top that is open. A lid is selectively attachable to the hopper to close the top. A chute is attached to the hopper and extends from an aperture that is positioned in a bottom of the hopper. A plate is attached to the hopper and is positioned to selectively close the aperture. An actuator is operationally engaged to the plate and is positioned to reversibly position the plate in an open configuration and a closed configuration. The dispensing apparatus can selectively dispense bird food from the hopper through the chute and onto the tray where it can be consumed by a bird.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to feeding devices and more particularly pertains to a new feeding device for automated addition of bird feed to a tray. The present invention discloses a feeding device that utilizes a dispenser to selectively release bird food from a hopper to a tray.

### (2) Description of Related Art Including Information Disclosed Under 37 CFR 1.97 and 1.98

The prior art relates to feeding devices, which may comprise hoppers having integral trays, wherein with phone controlled rams are used to open and close bottoms of the hoppers. The integral trays of the prior art provide limited surface areas upon which to deposit bird food. Related prior art comprises blowers that are used to transfer bird food from hoppers to bird feeders. What is lacking in the prior art is a feeding device comprising a dispenser to selectively release bird food from a hopper through a chute to a tray that is positioned below the chute.

### BRIEF SUMMARY OF THE INVENTION

An embodiment of the disclosure meets the needs presented above by generally comprising a dispensing apparatus and a tray, which are configured to be mountable to a support element, such as a post. The dispensing apparatus comprises a hopper, which has a top that is open. A lid is selectively attachable to the hopper to close the top. A chute is attached to the hopper and extends from an aperture that is positioned in a bottom of the hopper. A plate is attached to the hopper and is positioned to selectively close the aperture. An actuator is operationally engaged to the plate and is positioned to reversibly position the plate in an open configuration and a closed configuration. The dispensing apparatus thus is configured to selectively dispense bird food, which is positioned in the hopper, through the chute onto the tray, which is positioned below the chute, for consumption by a bird.

Another embodiment of the disclosure includes a bird feeding system comprises a post to which a dispensing apparatus and a tray, as described in the disclosure above, are mounted. Bird food is positioned in a hopper of the dispensing apparatus, which is positioned to selectively dispense the bird food through a chute of the dispensing apparatus onto the tray for consumption by a bird.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an isometric perspective view of a bird feeding device according to an embodiment of the disclosure.

FIG. 2 is an isometric perspective view of an embodiment of the disclosure.

FIG. 3 is a side view of an embodiment of the disclosure.

FIG. 4 is a front view of an embodiment of the disclosure.

FIG. 5 is a top view of an embodiment of the disclosure.

FIG. 6 is a cross-sectional view of an embodiment of the disclosure.

FIG. 7 is a block diagram of an embodiment of the disclosure.

### DETAILED DESCRIPTION OF THE INVENTION

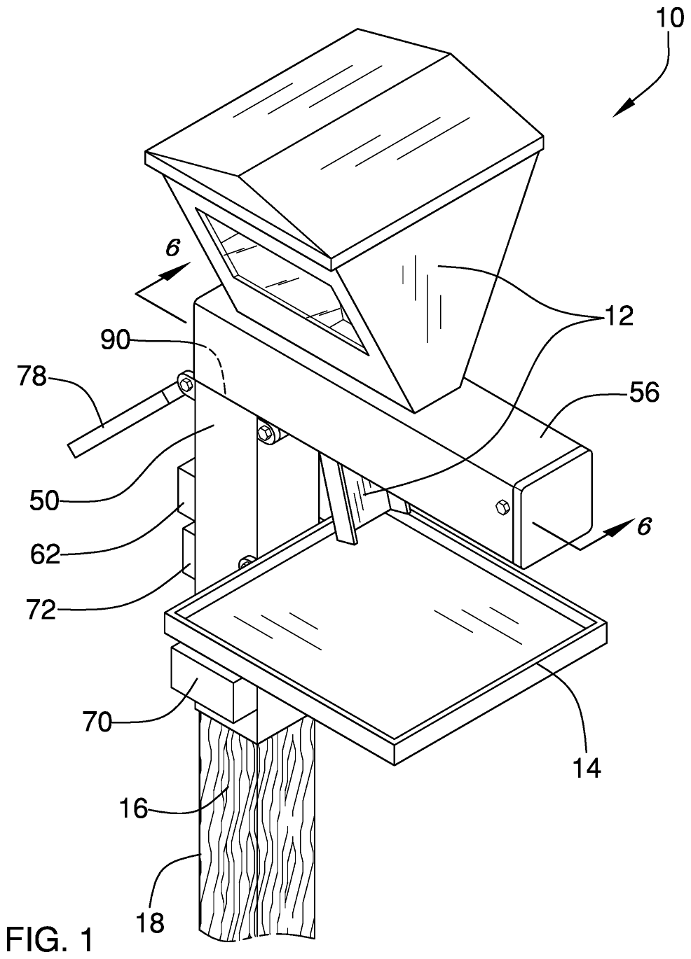

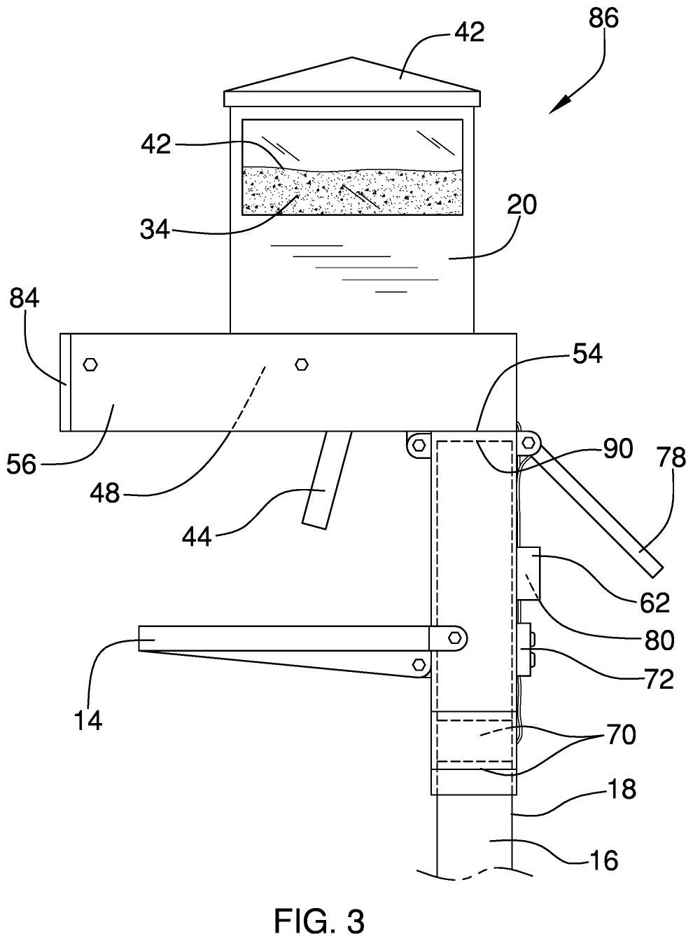

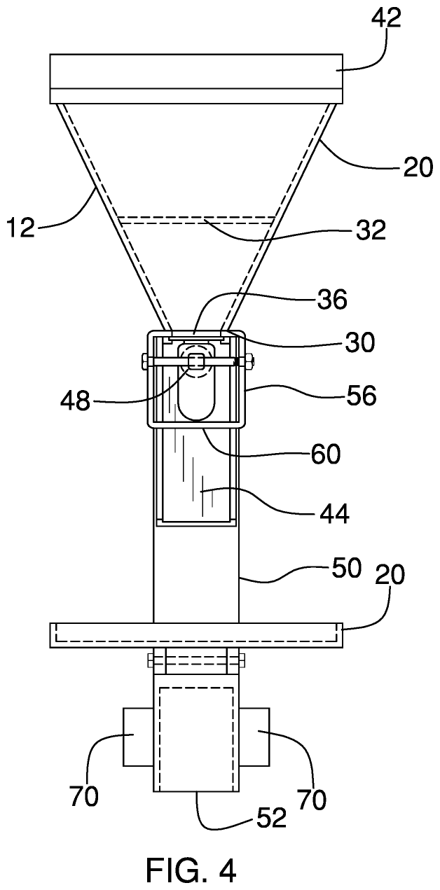

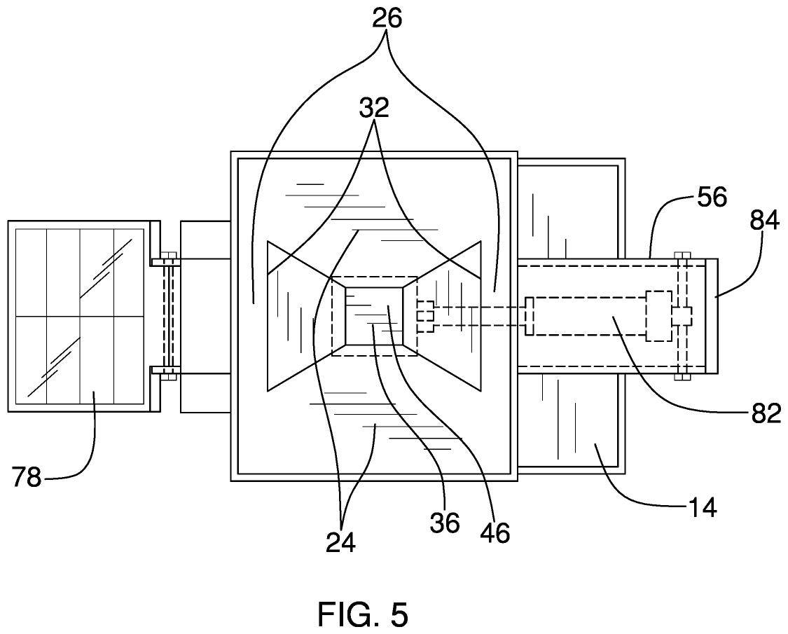

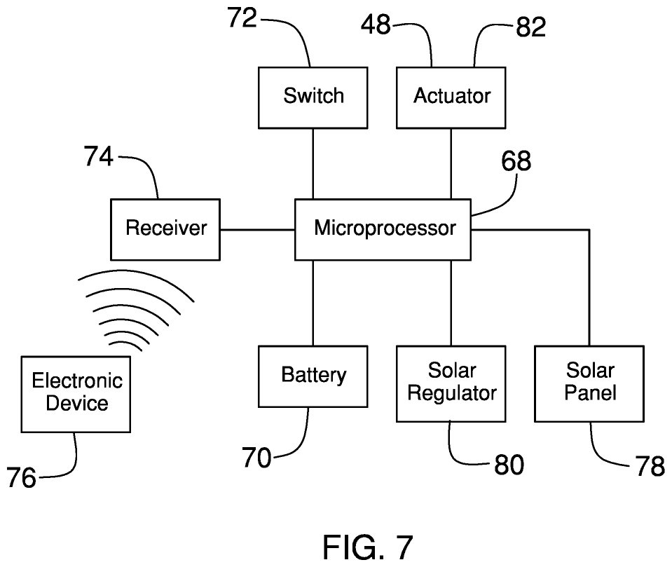

With reference now to the drawings, and in particular to FIGS. 1 through 7 thereof, a new feeding device embodying the principles and concepts of an embodiment of the disclosure and generally designated by the reference numeral 10 will be described.

As best illustrated in FIGS. 1 through 7, the bird feeding device 10 generally comprises a dispensing apparatus 12 and a tray 14, which are configured to be mountable to a support element 16. The present invention anticipates the dispensing apparatus 12 and the tray 14 being configured to be mountable to a variety of support elements 16, such as, but not limited to, a post 18, as shown in FIG. 1, poles, such as flag poles, rails, such as deck rails, or the like.

The dispensing apparatus 12 comprises a hopper 20, which has a top 22 that is open. The hopper 20 may comprise a pair of sidewalls 24 and a pair of end walls 26, the end walls 26 of which are substantially parallel. Each end wall 26 is attached to and extends between a respective opposed edge 28 of one sidewall 24 and an associated opposed edge 28 of the other sidewall 24. As shown in FIG. 1, the sidewalls 24 are rectangular and the end walls 26 are trapezoidal so that the top 22 is circumferentially larger than a bottom 30 of the hopper 20. The hopper 20 also may comprise a pair of feeder panels 32. Each feeder panel 32 is attached to and extends between the bottom 30 of the hopper 20 and a respective end wall 26. The feeder panels 32 are configured to direct bird food 34 in the hopper 20 to an aperture 36 that is positioned in the bottom 30 of the hopper 20. The present invention anticipates the hopper 20 being of a variety of other configurations, such as, but not limited to, cylindrical with a lower conical section, inverted square frustum, and the like.

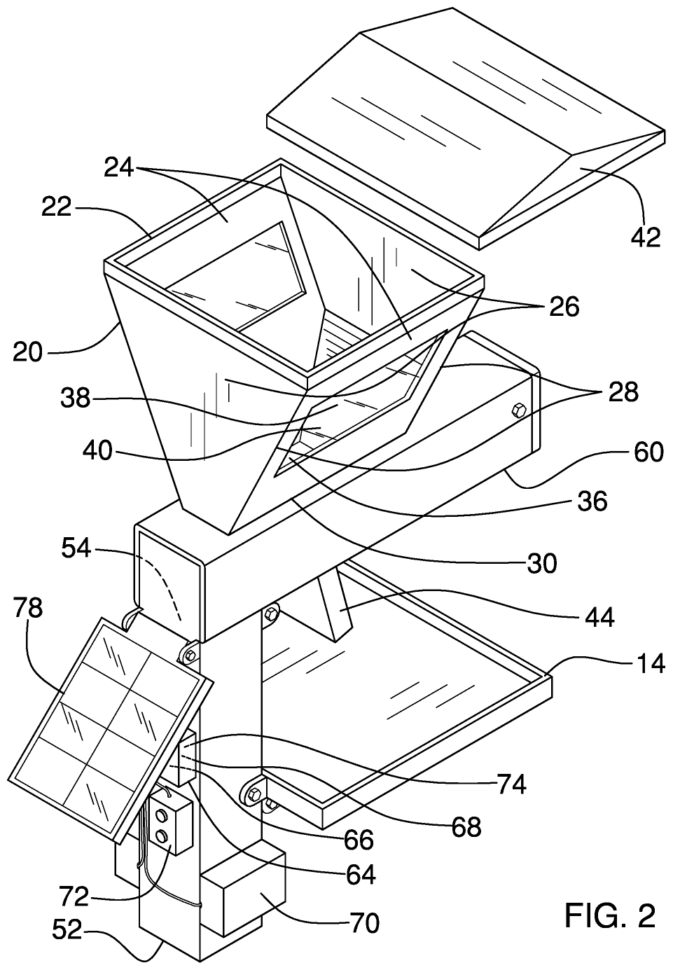

As shown in FIG. 1, a cutout 38 is positioned in a respective the sidewall 24 and a view panel 40 is attached to the respective the sidewall 24 to cover the cutout 38. The view panel 40 is configured to allow for viewing of a level 88 of the bird food 34 in the hopper 20. As shown in FIG. 2, the cutout 38 may be one of a pair of cutouts 38, which are positioned singly in the sidewalls 24. The present invention also anticipates one or more cutouts 38 being positioned in the end walls 26.

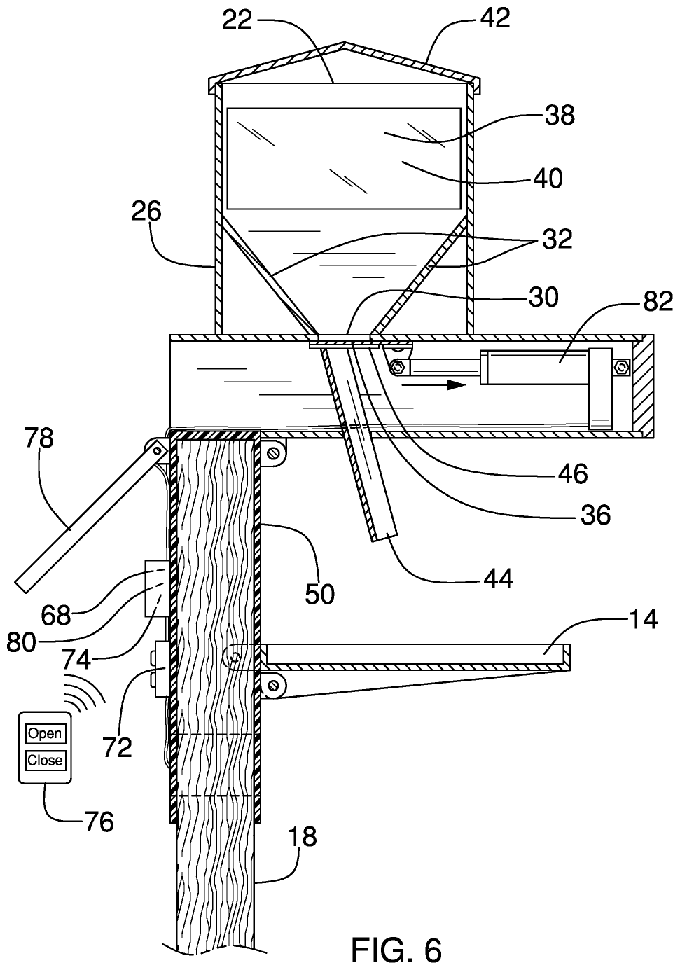

A lid 42 is selectively attachable to the hopper 20 to close the top 22. The present invention also anticipates the lid 42 being hingedly attached to the hopper 20. A chute 44 is attached to the hopper 20 and extends from the aperture 36 toward the tray 14. A plate 46 is attached to the hopper 20 and is positioned to selectively close the aperture 36. An actuator 48 is operationally engaged to the plate 46 and is positioned to reversibly position the plate 46 in an open configuration and a closed configuration, as shown in FIG. 6. The dispensing apparatus 12 thus is configured to selectively dispense the bird food 34 from the hopper 20 through the chute 44 and onto the tray 14 for consumption by a bird.

The bird feeding device 10 comprises a sleeve 50, which has an open end 52 and a closed end 54. The open end 52 is configured for insertion of a post 18 so that an upper end 90 of the post 18 engages the closed end 54 of the sleeve 50. As shown in FIG. 2, the sleeve 50 is rectangular, although the present invention anticipates the sleeve 50 being alternatively shaped, such as circular, oval, or the like, so as to match posts 18 that are similarly shaped. Rather than a sleeve 50, the dispensing apparatus 12 and the tray 14 might be attached to a mounting plate that is configured to be mounted to a support element 16 that is substantially vertical, such as a post 18, a wall, or the like.

A tube 56 is attached to the closed end 54 and extends substantially perpendicularly from the sleeve 50, with the hopper 20 being attached to an upper face 58 of the tube 56. The chute 44 extends through the tube 56 and protrudes from a lower face 60 of the tube 56. The tray 14 is attached to and extends substantially perpendicularly from the sleeve 50 so that the tray 14 is positioned below the chute 44.

The bird feeding device 10 also comprises a controller 62, which includes a housing 64 that defines an interior space 66. A microprocessor 68 is attached to the housing 64, positioned in the interior space 66, and operationally engaged to the actuator 48. A battery 70, which is rechargeable, is operationally engaged to the microprocessor 68. A switch 72 is operationally engaged to the microprocessor 68 and is configured to be selectively switched to signal the microprocessor 68 to actuate the actuator 48 to dispense the bird food 34 through the chute 44. As shown in FIG. 2, the controller 62, the battery 70, and the switch 72 are attached to the sleeve 50. The switch 72 may be two button type, as shown in FIG. 2, or may comprises other switching means, such as, but not limited to, toggles, slides, or the like. The present invention also anticipates the switch 72 being integral to the housing 64, being attached to the hopper 20, or being attached to the tray 14.

A receiver 74 is attached to the housing 64, positioned in the interior space 66, and operationally engaged to the microprocessor 68. The receiver 74 is configured to receive a signal from an electronic device 76 of a user so that the microprocessor 68 selectively actuates the actuator 48 to dispense the bird food 34 through the chute 44. The electronic device 76 may be a dedicated device, perhaps in the form a key fob, or may comprise smart phone, or the like, upon which programming code has been positioned allowing the electronic device 76 to signal the controller 62. The programming code might also enable creation of an automated dispensing regimen to be executed by the microprocessor 68, which would be useful for feeding birds during an absence of the user.

As shown in FIG. 2, a solar panel 78 is hingedly attached to the sleeve 50, although the present invention also anticipates the solar panel 78 being attached to the lid 42 or to a respective end wall 26. The solar panel 78 is operationally engaged to the microprocessor 68. The solar panel 78 is configured to convert electromagnetic radiation to an electrical current to charge the battery 70. A solar regulator 80 is attached to the housing 64, positioned in the interior space 66, and operationally engaged to the microprocessor 68. The solar regulator 80 regulates charging of the battery 70.

As shown in FIG. 6, the plate 46 is slidably attached to the hopper 20, although the present invention also anticipates the plate 46 being hingedly attached to the hopper 20. The actuator 48 comprises a linear actuator 82 that is positioned to selectively slide the plate 46 between the closed configuration and the open configuration. Also as shown in FIG. 6, the linear actuator 82 is positioned in the tube 56 and is accessible for maintenance by means of an endcap 84, which is removably attachable to the tube 56. The present invention anticipates the actuator 48 comprises other actuating means, such as, but not limited to, racks and pinions, pulley, or the like.

The present invention also anticipates a bird feeding system 86, which comprises a post 18 to which a dispensing apparatus 12 and a tray 14, as described in the specification above, are mounted. Bird food 34 is positioned in a hopper 20 of the dispensing apparatus 12, which is positioned to selectively dispense the bird food 34 through a chute 44 of the dispensing apparatus 12 onto the tray 14 for consumption by a bird.

In use, the sleeve 50 of the bird feeding device 10 is positioned over a post 18 and bird food 34 is added to the hopper 20. The solar panel 78 is hinged to an optimal configuration for exposure to sunlight to keep the battery 70 charged. The actuator 48 then can be actuated, as needed using either the switch 72 or the electronic device 76, to dispense the bird food 34 from the hopper 20 to the tray 14 to feed birds.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A bird feeding device comprising:
a dispensing apparatus configured to be mountable to a support element, the dispensing apparatus comprising:
a hopper having a top, the top being open,
a lid selectively attachable to the hopper for closing the top,
an aperture positioned in a bottom of the hopper,
a chute attached to the hopper and extending from the aperture,
a plate attached to the hopper and being positioned for selectively closing the aperture, and
an actuator operationally engaged to the plate, such that the actuator is positioned for reversibly positioning the plate in an open configuration and a closed configuration; and
a tray configured to be mountable to the support element, such that the tray is positioned below the chute, wherein the dispensing apparatus is configured for selectively dispensing bird food positioned in the hopper through the chute onto the tray for consumption by a bird.

2. The bird feeding device of claim 1, wherein the hopper comprises:
a pair of sidewalls, the sidewalls of the pair of sidewalls being rectangular; and
a pair of end walls, the end walls of the pair of end walls being trapezoidal, each end wall of the pair of end walls being attached to and extending between a respective opposed edge of one sidewall of the pair of sidewalls and an associated opposed edge of the other sidewall of the pair of sidewalls, such that the end walls of the pair of end walls are substantially parallel and such that the top is circumferentially larger than the bottom.

3. The bird feeding device of claim 2, further including a pair of feeder panels, each feeder panel of the pair of feeder panels being attached to and extending between the bottom of the hopper and a respective end wall of the pair of end walls, wherein the pair of feeder panels is configured for directing the bird food in the hopper to the aperture.

4. The bird feeding device of claim 1, further including:
a cutout positioned in a respective the sidewall of the pair of sidewalls; and
a view panel attached to the respective the sidewall of the pair of sidewalls and covering the cutout, wherein the view panel is configured to allow for viewing of a level of the bird food in the hopper.

5. The bird feeding device of claim 1, further including:
a sleeve having an open end and a closed end, wherein the open end is configured for insertion of a post, such that an upper end of the post engages the closed end of the sleeve;
a tube attached to the closed end and extending substantially perpendicularly from the sleeve, the hopper being attached to an upper face of the tube, the chute extending through the tube and protruding from a lower face of the tube; and
the tray being attached to and extending substantially perpendicularly from the sleeve, such that the tray is positioned below the chute.

6. The bird feeding device of claim 1, further including:
a controller comprising:
a housing defining an interior space, and
a microprocessor attached to the housing, positioned in the interior space, and operationally engaged to the actuator;
a battery operationally engaged to the microprocessor; and
a switch operationally engaged to the microprocessor, wherein the switch is configured for being selectively switched for signaling the microprocessor for actuating the actuator for dispensing the bird food through the chute.

7. The bird feeding device of claim 6, further including:
a sleeve having an open end and a closed end, wherein the open end is configured for insertion of a post, such that an upper end of the post engages the closed end of the sleeve; and
the controller, the battery, and the switch being attached to the sleeve.

8. The bird feeding device of claim 6, further including a receiver attached to the housing, positioned in the interior space, and operationally engaged to the microprocessor, wherein the receiver is configured for receiving a signal from an electronic device of a user, such that the microprocessor selectively actuates the actuator for dispensing the bird food through the chute.

9. The bird feeding device of claim 6, further including:
the battery being rechargeable;
a solar panel operationally engaged to the microprocessor, wherein the solar panel is configured for converting electromagnetic radiation to an electrical current for charging the battery; and
a solar regulator attached to the housing, positioned in the interior space, and operationally engaged to the microprocessor, wherein the solar regulator is configured for regulating charging of the battery.

10. The bird feeding device of claim 9, further including:
a sleeve having an open end and a closed end, wherein the open end is configured for insertion of a post, such that an upper end of the post engages the closed end of the sleeve; and
the solar panel being hingedly attached to the sleeve.

11. The bird feeding device of claim 1, wherein:
the plate is slidably attached to the hopper; and
the actuator comprises a linear actuator, such that the linear actuator is positioned for selectively sliding the plate between the closed configuration and the open configuration.

12. A bird feeding system comprising:
a post;
a dispensing apparatus mounted to the post, the dispensing apparatus comprising:
a hopper having a top, the top being open,
a lid selectively attachable to the hopper for closing the top,
an aperture positioned in a bottom of the hopper,
a chute attached to the hopper and extending from the aperture,
a plate attached to the hopper and being positioned for selectively closing the aperture, and
an actuator operationally engaged to the plate, such that the actuator is positioned for reversibly positioning the plate in an open configuration and a closed configuration;
bird food positioned in the hopper; and
a tray mounted to the post and positioned below the chute, such that the dispensing apparatus is positioned for selectively dispensing the bird food through the chute onto the tray for consumption by a bird.

13. The bird feeding system of claim 12, further including:
a sleeve having an open end and a closed end, the sleeve being positioned over the post, such that an upper end of the post engages the closed end of the sleeve;
a tube attached to the closed end and extending substantially perpendicularly from the sleeve, the hopper being attached to an upper face of the tube, the chute extending through the tube and protruding from a lower face of the tube; and
the tray being attached to and extending substantially perpendicularly from the sleeve, such that the tray is positioned below the chute.

14. A bird feeding device comprising:
a dispensing apparatus configured to be mountable to a support element, the dispensing apparatus comprising:
a hopper having a top, the top being open, the hopper comprising:
a pair of sidewalls, the sidewalls of the pair of sidewalls being rectangular,
a pair of end walls, the end walls of the pair of end walls being trapezoidal, each end wall of the pair of end walls being attached to and extending between a respective opposed edge of one sidewall of the pair of sidewalls and an associated opposed edge of the other sidewall of the pair of sidewalls, such that the end walls of the pair of end walls are substantially parallel and such that the top is circumferentially larger than the bottom,
a cutout positioned in a respective the sidewall of the pair of sidewalls, and
a view panel attached to the respective the sidewall of the pair of sidewalls and covering the cutout, wherein the view panel is configured to allow for viewing of a level of bird food in the hopper,
a lid selectively attachable to the hopper for closing the top,
an aperture positioned in a bottom of the hopper,
a chute attached to the hopper and extending from the aperture,
a pair of feeder panels, each feeder panel of the pair of feeder panels being attached to and extending between the bottom of the hopper and a respective end wall of the pair of end walls, wherein the pair of feeder panels is configured for directing the bird food in the hopper to the aperture,
a plate attached to the hopper and being positioned for selectively closing the aperture, and
an actuator operationally engaged to the plate, such that the actuator is positioned for reversibly positioning the plate in an open configuration and a closed configuration; and
a tray configured to be mountable to the support element, such that the tray is positioned below the chute, wherein the dispensing apparatus is configured for selectively dispensing the bird food positioned in the hopper through the chute onto the tray for consumption by a bird;
a sleeve having an open end and a closed end, wherein the open end is configured for insertion of a post, such that an upper end of the post engages the closed end of the sleeve;
a tube attached to the closed end and extending substantially perpendicularly from the sleeve, the hopper being attached to an upper face of the tube, the chute extending through the tube and protruding from a lower face of the tube;
the tray being attached to and extending substantially perpendicularly from the sleeve, such that the tray is positioned below the chute;
a controller comprising:
a housing defining an interior space, the controller being attached to the sleeve, and
a microprocessor attached to the housing, positioned in the interior space, and operationally engaged to the actuator;
a battery operationally engaged to the microprocessor, the battery being attached to the sleeve, the battery being rechargeable;
a switch operationally engaged to the microprocessor, wherein the switch is configured for being selectively switched for signaling the microprocessor for actuating the actuator for dispensing the bird food through the chute, the switch being attached to the sleeve;
a receiver attached to the housing, positioned in the interior space, and operationally engaged to the microprocessor, wherein the receiver is configured for receiving a signal from an electronic device of a user, such that the microprocessor selectively actuates the actuator for dispensing the bird food through the chute;
a solar panel operationally engaged to the microprocessor, wherein the solar panel is configured for converting electromagnetic radiation to an electrical current for charging the battery, the solar panel being hingedly attached to the sleeve;
a solar regulator attached to the housing, positioned in the interior space, and operationally engaged to the microprocessor, wherein the solar regulator is configured for regulating charging of the battery;
the plate being slidably attached to the hopper; and
the actuator comprising a linear actuator, such that the linear actuator is positioned for selectively sliding the plate between the closed configuration and the open configuration.
